(19) United States
(12) Patent Application Publication
(10) Pub. No.: US 2015/0042456 A1
(43) Pub. Date: Feb. 12, 2015

(54) APPARATUSES, SYSTEMS, AND METHODS FOR WIRELESS SENSING

(71) Applicant: HAIYU HUANG, PFLUEGERVILLE, TX (US)

(72) Inventor: HAIYU HUANG, PFLUEGERVILLE, TX (US)

(21) Appl. No.: 14/457,085

(22) Filed: Aug. 11, 2014

Related U.S. Application Data
(60) Provisional application No. 61/864,731, filed on Aug. 12, 2013.

(51) Int. Cl. G06K 7/10

(52) U.S. Cl. CPC G06K 7/10366
USPC 340/10.1

(57) ABSTRACT

This disclosure describes various embodiments of apparatuses, systems, and methods for wireless sensing. In some embodiment, a first signal comprising a first frequency f₁ and a second signal comprising a second frequency f₂ are used as interrogating signals. A third signals comprising a third frequency f₃ is generated with an object, and a measurement of the object is determined based on the third signal. Frequency f₃ is determined by formula f₃=m×f₁+n×f₂, where m, n are real numbers (positive, negative, or zero). In particular, the third signal may be emitted at one or more of the harmonic frequencies associated with the frequencies of the first and/or the second signal. In some embodiments, a first signal comprising a first frequency is used as an interrogating signal, and a second signal comprising a frequency different from the first frequency is generated by a sensing device exposed to an object, the sensing device comprising a nonlinear transistor. A measurement of the object is then determined based on the second signal.

### CROSS-REFERENCE TO RELATED APPLICATIONS

This application claims priority to U.S. Provisional Application No. 61/864,731, entitled “Apparatuses, Systems, and Methods for Wireless Sensing,” filed Aug. 12, 2013, the entire contents of which is specifically incorporated by reference herein.

### BACKGROUND

1. Field of the Invention

This invention relates generally to sensing systems, and more particularly, but not by way of limitation, to apparatuses, systems and methods for wireless sensing.

2. Description of Related Art

Radio-frequency identification (RFID) is the wireless non-contact use of radio-frequency electromagnetic fields to transfer data for the purposes of automatically identifying and tracking tags attached to objects. The tags contain electronically stored information. Some tags are powered and read at short ranges (a few meters) via magnetic fields (electromagnetic induction). Others use a local power source such as a battery, or have no battery but collect energy from the interrogating EM field, and then act as a passive transponder to emit microwaves or UHF radio waves (i.e., electromagnetic radiation at high frequencies). Battery powered tags may operate at hundreds of meters. Unlike a bar code, the tag does not necessarily need to be within line of sight of the reader, and may be embedded in the tracked object.

RFID tags are used in many industries. An RFID tag attached to an automobile during production can be used to track its progress through the assembly line. Pharmaceuticals can be tracked through warehouses. Livestock and pets may have tags injected, allowing positive identification of the animal. On off-shore oil and gas platforms, RFID tags are worn by personnel as a safety measure, allowing them to be located 24 hours a day and to be quickly found in emergencies.

In current RFID systems, an RFID reader transmits an interrogating signal at a certain frequency. The signal reaches a RFID tag and then reflected back to the reader, which receives and determines the information from the tag. The information can be not only the stored data in the chip of the tag, but also sensing information if the tag has a sensor module or the tag antenna is used as a sensor. Because the RFID tag simply reflects the interrogating signal back, the reflected signal has the same frequency as the interrogating signal. There are strong direct coupling between transmitting and receiving paths. Furthermore, if there are other objects near the RFID reader and tag, the interrogating signal may be reflected back to the RFID reader as well, which creates interferences and degrades the performance of the RFID system. Therefore, there is a need to reduce direct coupling and interferences in wireless sensing systems such as an RFID system and improve the performance of such wireless sensing systems.

### SUMMARY

Embodiments of systems, apparatuses, and methods for wireless sensing are presented. In an embodiment, the methods and systems comprise transmitting one or more interrogating signals at distinct frequencies, and receiving a responsive signal from an object at a responsive frequency, wherein the responsive frequency is a multiple of at least one of the frequency of the one or more interrogating signals. For example, an antenna may transmit a first signal comprising a first frequency, and a sensor device may respond with a responsive signal at a second frequency that is an integer multiple of the first frequency. In an embodiment, the frequency of the responsive signal may be at a second or third harmonic of the first frequency.

In one embodiment, the method includes transmitting a first signal comprising a first frequency. The method may also include transmitting a second signal comprising a second frequency. Additionally, the method may include receiving a third signal comprising a third frequency. In an embodiment, the third signal may be generated with an object and based on the first signal and the second signal. In such an embodiment, the third frequency may be a multiple of at least one of the first frequency and the second frequency. In some embodiments one or more of the first signal, the second signal, and the third signal may be broadband signals. In other embodiments, one or more of the first signal, the second signal, and the third signal may be narrowband signals.

In an embodiment, the method includes comparing the third signal with one or more time-varying reference signals. For example, one or more of the first signal, the second signal, or the third signal may be a time-varying signal. In a particular embodiment, the time-varying signal may be a spread-spectrum signal. In other embodiments, the signal may vary in a pattern defined by an industry standard, such as Code Division Multiple Access (CDMA) or Frequency Hopping Spread Spectrum (FHSS). In an embodiment, the third frequency of the third signal is different from the first frequency of the first signal, and from the second frequency of the second signal.

In some embodiments, the third signal is generated by a component coupled to an object, and a property of the third signal is related to a measurement of the object. The object may be a container and the measurement is a level of filling in the container, for example. In other embodiments, the object is food and the measurement is a quality of the food. In another embodiment, the object is a part of living tissue and the measurement is the abnormality or normality of the tissue.

In one embodiment, the method includes receiving a first signal comprising a first frequency. The method may also include receiving a second signal comprising a second frequency. In an embodiment, the method includes transmitting a third signal comprising a third frequency, the third signal generated based on the first signal and the second signal, wherein the third frequency is a multiple of at least one of the first frequency and the second frequency.

In an embodiment, the third frequency of the third signal is different from the first frequency of the first signal, and from the second frequency of the second signal. The third signal may be generated by a component coupled to an object, and a property of the third signal is related to a measurement of the object. Additionally, the method may include comparing the third signal with one or more time varying reference signals.

In an embodiment, an apparatus may include a transmitter configured to transmit a first signal comprising a first frequency and a second signal comprising a second frequency. The apparatus may also include a receiver configured to receive a third signal comprising a third frequency, the third signal generated with an object and based on the first signal and the second signal, wherein the third frequency is a multiple of at least one of the first frequency and the second frequency. Additionally, the apparatus may include a processor configured to compare the third signal with one or more time-varying reference signals.

In another embodiment, an apparatus may include a receiver configured to receive a first signal comprising a first frequency and a second signal comprising a second frequency. The apparatus may also include a circuit configured to generate a third signal comprising a third frequency based on the first signal and the second signal. Additionally, the apparatus may include a transmitter configured to transmit the third signal, wherein the third frequency is a multiple of at least one of the first frequency and the second frequency.

The feature or features of one embodiment may be applied to other embodiments, even though not described or illustrated, unless expressly prohibited by this disclosure or the nature of the embodiments.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as non-identical reference numbers.

FIG. 1 illustrates an RFID system.

FIG. 2 illustrates one embodiment of a system for wireless sensing.

FIG. 3 illustrates one embodiment of a method for wireless sensing.

FIGS. 4A and 4B illustrate graphs of signal characteristics used in a method for wireless sensing.

FIG. 5 illustrates one embodiment of a method for wireless sensing.

FIG. 6 illustrates one embodiment of a system for wireless sensing.

FIG. 7 illustrates one embodiment of a method for wireless sensing.

FIG. 8 illustrates examples of signals used in a method for wireless sensing.

FIG. 9 illustrates one embodiment of a method for wireless sensing.

FIG. 10 illustrates one embodiment of a system for wireless sensing.

FIG. 11 illustrates one embodiment of a method for wireless sensing.

FIG. 12 illustrates a graph of signal characteristics for a method for wireless sensing.

FIG. 13 illustrates one embodiment of a method for wireless sensing.

FIG. 14 illustrates one embodiment of a system for wireless sensing.

FIG. 15 illustrates one embodiment of a system for wireless sensing.

FIG. 16 illustrates one embodiment of a system for wireless sensing.

FIG. 17 illustrates one embodiment of a system for wireless sensing.

### DETAILED DESCRIPTION OF ILLUSTRATIVE EMBODIMENTS

Various features and advantageous details are explained more fully with reference to the non-limiting embodiments that are illustrated in the accompanying drawings and detailed in the following description. Descriptions of well-known starting materials, processing techniques, components, and equipment may be omitted for brevity. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those having ordinary skill in the art from this disclosure.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system or apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, a device or system that is configured in a certain way is configured in at least that way, but it can also be configured in other ways than those specifically described.

The described methods and systems use signals at different frequencies to reduce interferences and improve performance of wireless sensing systems. In an embodiment, the methods and systems comprise transmitting one or more interrogating signals at distinct frequencies, and receiving a responsive signal from an object at a responsive frequency, wherein the responsive frequency is a multiple of at least one of the frequency of the one or more interrogating signals. For example, an antenna may transmit a first signal comprising a first frequency, and a sensor device may respond with a responsive signal at a second frequency that is an integer multiple of the first frequency. In an embodiment, the frequency of the responsive signal may be at a second or third harmonic of the first frequency.

In one embodiment, the wireless sensing system comprises a reader apparatus and a sensing apparatus. In one embodiment, the reader apparatus comprise a first antenna configured to transmit a first signal comprising a first frequency f₁ and a second signal comprising a second frequency f₂, a second antenna configured to receive a third signal comprising a third frequency f₃, where the third signal generated with an object and based on the first signal and the second signal, and a processor configured to determine a measurement of the object based on the third signal. Third frequency f₃ is determined by formula f₃=m×f₁+n×f₂, where m, n are real numbers (positive, negative, or zero). In some embodiments, the third frequency of the third signal equals to the sum of (i.e., m=1, n=1) or the difference (i.e., m=1, n=−1; or m=−1, n=1) between the first and second frequencies.

The sensing apparatus may comprise a first antenna configured to receive a first signal comprising a first frequency f₁ and a second signal comprising a second frequency f₂, a circuit configured to generate a third signal comprising a third frequency f₃ based on the first signal and the second signal, and a second antenna configured to transmit the third signal. Frequency f₃ is determined by formula f₃=m×f₁+n×f₂, where m, n are real numbers (positive, negative, or zero). In some embodiments, the third frequency of the third signal equals to the sum of (i.e., m=1, n=1) or the difference (i.e., m=1, n=−1; or m=−1, n=1) between the first and second frequencies. The sensing apparatus may further comprise a radio frequency circuit, a frequency mixer, and/or a frequency multiplier.

The third frequency of the third signal is different from the first frequency of the first signal, and from the second frequency of the second signal. The third signal may be generated by a component coupled with an object, and strength of the third signal is related to a measurement of the object. The circuit may comprise a radio frequency circuit, such as a RFID circuit. Determining the measurement of the object may comprise comparing the third signal with a reference signal.

In another embodiment, the reader apparatus may comprise a first antenna configured to transmit a first signal comprising a first frequency, a second antenna configured to receive a second signal comprising a second frequency different from the first frequency, the second signal generated with a sensing circuit exposed to an object and generated based on the first signal, a processor configured to determine a measurement of the object based on the second signal, where the sensing circuit comprises a nonlinear transistor. The object may be a bio-agent and the measurement may be a level of the bio-agent. The object may also a toxic gas and the measurement may be a level of the gas.

The sensing apparatus may comprise a first antenna configured to receive a first signal comprising a first frequency, a sensing circuit exposed to an object and configured to generate a second signal comprising a second frequency different from the first frequency based on the first signal, and a second antenna configured to transmit the second signal, where the sensing circuit comprise a nonlinear transistor.

Embodiments of methods for wireless sensing are also presented. In one embodiment, the method for wireless sensing may comprise transmitting a first signal comprising a first frequency, transmitting a second signal comprising a second frequency, receiving a third signal comprising a third frequency, the third signal generated with an object and based on the first signal and the second signal, and determining a measurement of the object based on the third signal. The third frequency of the third signal equals to the sum of or the difference between the first frequency and second frequency. Determining the measurement of the object may further comprise comparing the third signal with a reference signal. The third signal may be generated by a component coupled to the object, and strength of the third signal may be related to a measurement of the object.

The object may be a container and the measurement may be a level of filling, e.g., water, soda, alcohol, or other drinks, in the container. The object may be food and the measurement may be the quality of the food. The object may be a part of living tissue, such as a breast of a woman, and the measurement may be the abnormality or normality of the tissue. The object may also be a drug and the measurement may be the amount of the drug.

In one embodiment, the method for wireless sensing may comprise receiving a first signal comprising a first frequency, receiving a second signal comprising a second frequency, transmitting a third signal comprising a third frequency, and the third signal generated based on the first signal and the second signal, where the third frequency of the third signal equals to the sum of or the difference between the first frequency and second frequency. The third frequency of the third signal may be different from the first frequency of the first signal, and from the second frequency of the second signal. The third signal may be generated by a circuit, e.g., a radio frequency circuit, coupled to an object, and strength of the third signal may be related to a measurement of the object.

In one embodiment, the method for wireless sensing may comprise transmitting a first signal comprising a first frequency, receiving a second signal comprising a second frequency different from the first frequency, the second signal generated with a sensing circuit exposed to an object and based on the first signal, and determining a measurement of the object based on the second signal, where the sensing circuit comprises a nonlinear transistor. Determining the measurement of the object may further comprise comparing the second signal with a reference signal. The object may be a bio-agent and the measurement may be a level of the bio-agent. The object may be a toxic gas and the measurement may be a level of the gas.

In one embodiment, the method for wireless sensing may comprise receiving a first signal comprising a first frequency, transmitting a second signal comprising a second frequency different from the first frequency, the second signal generated with a sensing circuit exposed to an object and based on the first signal, where the sensing circuit may comprise a nonlinear transistor. Strength of the second signal may be related to a measurement of the object.

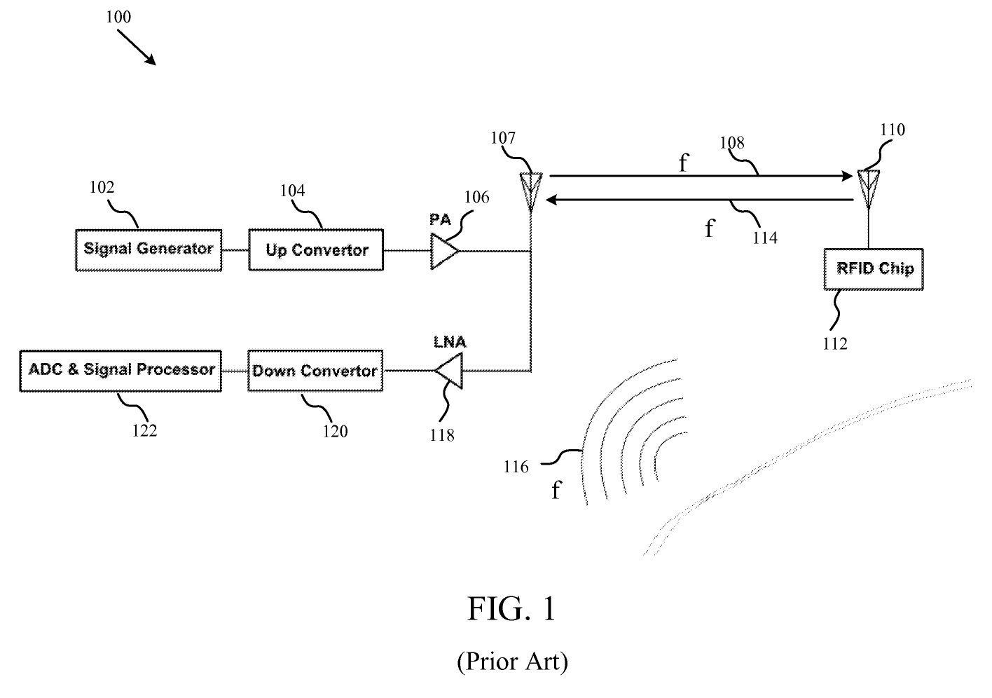

FIG. 1 illustrates a RFID system 100 in the prior art. In this system, a signal generator 102 generates an interrogating signal, which may be up-converted by an up-converter 104 to a frequency f and amplified by PA 106 (power amplifier) and then the signal 108 at frequency f is transmitted by antenna 107 to antenna 110 at a RFID tag 112. Upon receiving the signal 108, antenna 110 transmits signal 114 at frequency f back to antenna 107, where signal 114 passes through a LNA 118 (low noise amplifier), down converter 120, and is processed at processor 122. The RFID system 100 suffers from interferences and direct coupling, which results in performance degradation. When there are objects around the RFID tag, and/or between antennas 107 and 110, signals 108 and/or 114 are reflected back to antenna 107, creating interference signal 116 and thus reducing the accuracy of the RFID reader.

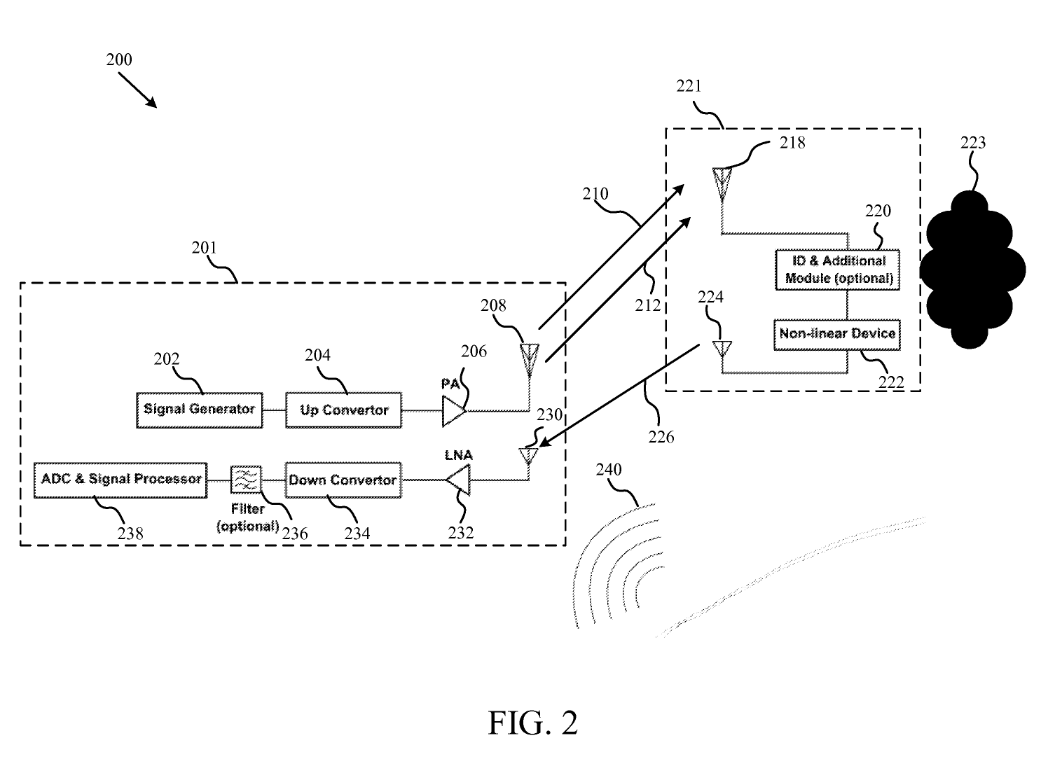

FIG. 2 illustrates one embodiment of a system 200 for wireless sensing. The system 200 may comprise a reader 201 and a sensing apparatus 221. In one embodiment, the reader 201 may comprise a signal generator 202, a frequency up-converter 204, a power amplifier 206, and a transmitting antenna 208. The reader 201 may also comprise a receiving antenna 230, a low noise amplifier 232, a down converter 234, an optional filter 236, and a signal processor 238. Reader 201 may also comprise an optional analog to digital converter (ADC). In one embodiment, the sensing apparatus 221 may comprise a receiving antenna 218, a non-linear device 222, a transmitting antenna 224, and an optional module 220. In one embodiment, reader 201 and/or sensing apparatus 221 may comprise one or more radio frequency circuits. Sensing apparatus 221 may be included in a RFID tag.

Signal generator 202 may be configured to generate signals at certain frequencies. In system 200, the signal generator 202 along with frequency up-converter 204 may be configured to generate signals at two or more frequencies, i.e., a first signal 210 at a first frequency f₁ and a second signal 212 at a second frequency f₂. The first signal 210 and second signal 212 may be then up-converted by up-converter 204, i.e. the frequencies of the first and second signals 210, 212 are increased by modulating the signals to a carrier signal at a predetermined frequency. Frequencies of the first signal 210 and second signal 212, after frequency up-converting, may be represented as f₁ and f₂, respectively. The first signal 210 and second signal 212 may then be amplified by power amplifier 206 and transmitted by antenna 208. First signal 210 and second signal 212 may be transmitted simultaneously or at different times. In some embodiments, first signal 210 and second signal 212 may be two different frequency components of a signal, which has a plurality of frequency components.

Receiving antenna 218 of the sensing apparatus 221 receives the first signal 210 (at frequency f₁) and second signal 212 (at frequency f₂) and passes the signals 210 and 212 to non-linear device 222. In one embodiment, non-linear device 222 may be a frequency mixer. In such an embodiment, non-linear device 222 generates a third signal 226 comprising a third frequency f₃. Frequency f₃ is determined by formula f₃=m×f₁+n×f₂, where m, n are real numbers (positive, negative, or zero). In some embodiments, the third frequency of the third signal equals to the sum of (i.e., m=1, n=1) or the difference (i.e., m=1, n=−1; or m=−1, n=1) between the first and second frequencies. The frequency of signal 226 is different from frequency of signal 210 and frequency of signal 212. Optional circuit 220 may comprise a device with an identification unit, or other components such as a separate gauge or the like.

In a particular embodiment, the reader 201 may transmit only a first signal 210, and the third signal 226 may be at a frequency that is a multiple of the frequency of the first signal 210. In such an embodiment, the sensing apparatus may include a frequency doubler configured to receive the first signal 210 and generate the third signal 226 at a frequency that is twice the frequency of the first signal 210.

Antenna 218 antenna 224, and/or non-linear device 222, and/or some other module 220 may be coupled to an object 223, which acts as a substrate for non-linear device 222. The strength of the output signals generated by non-linear device 222 and transmitted by antenna 224 may vary with one or more characteristics and/or measurements of object 223. For example, if object 223 is a container, the strength of signal 226 may vary with the level of fillings in the container, or with different fillings, e.g., water, soda, alcohol, or other fluids; if object 223 is food, the strength of signal 226 may vary with the quality of the food; if object 223 is medicine, e.g., medicine in a capsule (e.g. in a human or animal body), the strength of signal 226 may vary with the remaining amount of the medicine; if object 223 is a living tissue, e.g., a breast of a female, the strength of signal 226 may vary with the amount of one or more tumors in the breast.

In another embodiment, non-linear device 222 may also be a frequency multiplier, and/or other non-linear devices that change the frequency of input signals. When non-linear device 222 is a frequency multiplier, the frequencies of the output signals are integer multiples of the frequency of the input signal. In one embodiment, non-linear device 222 may comprise a radio frequency circuit.

Signal 226 may be transmitted by transmitting antenna 224 of the sensing apparatus 221 to receiving antenna 230 of reader 201, where antenna 230 is configured to accept signals at a frequency that equals to the sum of frequencies of signals 210 and 212, and/or the difference between frequencies of signals 210 and 212 (i.e., the frequency of signal 226), and reject signals at other frequencies. Because interference 240 mainly comprises reflections of signals 210 and 212, which have different frequencies from signal 226, interference signal 240 is largely rejected by antenna 230, improving the performance of the wireless sensing system 200.

Signal 226 may be passed through a low noise amplifier 232, a down converter 234, where the frequency of signal 226 may be reduced by removing a carrier signal, an optional filter 236 and reach analog-to-digital converter and signal processor 238. Signal processor 238 measures the strength of the received signal 226 and determines a measurement of the object 223. Signal processor 238 may determine a measurement of object 223 by simply evaluating the strength of received signal 226, or by comparing the strength of received signal 226 with strength of a reference signal, or with a predetermined threshold. For example, when object 223 is food, signal processor 238 may determine a quality scale of the food; when object 223 is a container, signal processor 238 may determine whether the filling of the container has exceeded or fallen below a predetermined threshold; when object 223 is a medicine, signal processor 238 may determine whether the amount of the medicine is below a predetermined threshold; when object 223 is a breast of a female, signal processor 238 may determine whether there is a tumor in the breast. One of ordinary skill will recognize alternative signal properties which may be adjusted to relay measurement information. For example, rather than varying the strength of the signal, the frequency or phase of the signal may be adjusted. In another embodiment, the signal may be modulated to encode the measurement information. One of ordinary skill will recognize a variety of alternative methods and implementations.

The schematic flow chart diagrams that follow are generally set forth as logical flow chart diagrams. As such, the depicted order and labeled steps are indicative of some of the present embodiments. Other steps and methods may be employed that vary in some details from the illustrated embodiment (e.g., that are equivalent in function, logic, and/or effect). Additionally, the format and symbols employed are provided to explain logical steps and may be understood as non-limiting the scope of an invention. Although various arrow types and line types may be employed in the flow chart diagrams, they may be understood as non-limiting the scope of the corresponding method. Indeed, some arrows or other connectors may be used to indicate only the logical flow of the method. For instance, an arrow may indicate a waiting or monitoring period of unspecified duration between enumerated steps. Additionally, the order in which a particular method occurs may or may not strictly adhere to the order of the corresponding steps shown.

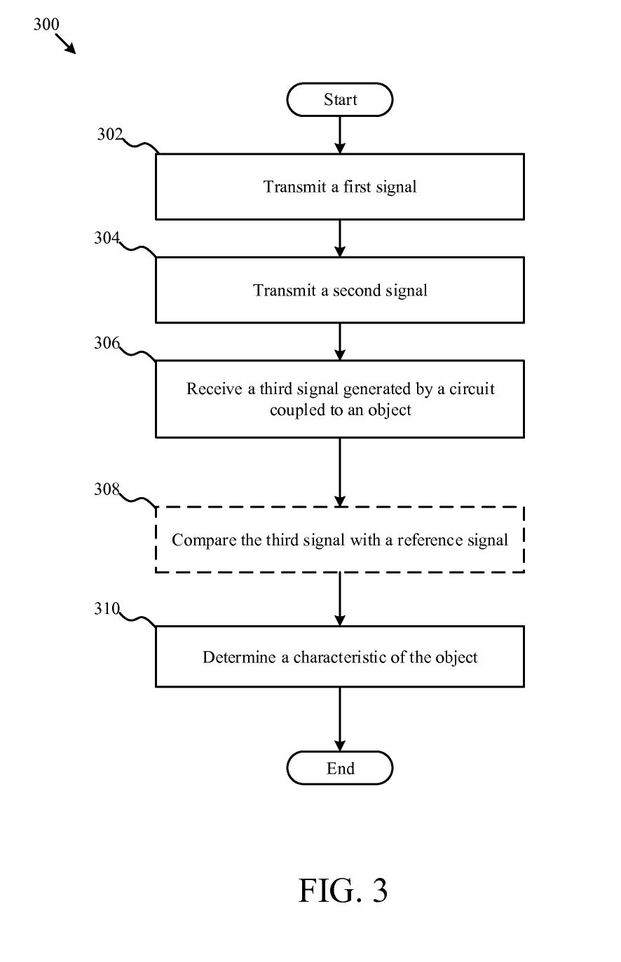

FIG. 3 illustrates one embodiment of method 300 for wireless sensing with system 200. In one embodiment, the method 300 comprises transmitting 302 a first signal comprising a first frequency f₁, transmitting 304 a second signal comprising a second frequency f₂, and receiving 306 a third signal (at frequency f₃) generated with an object. Frequency f₃ is determined by formula f₃=m×f₁+n×f₂, where m, n are real numbers (positive, negative, or zero). In some embodiments, the third frequency of the third signal equals to the sum of (i.e., m=1, n=1) or the difference (i.e., m=1, n=−1; or m=−1, n=1) between the first and second frequencies. The third signal may be generated by a sensing component coupled to the object, and based on the first and second signals. Strength of the third signal varies with a measurement and/or characteristic of the object (see discussions above). Method 300 further comprises determining 310 a measurement and/or characteristic of the object, e.g., by evaluating the strength of the third signal. Method 300 may optionally comprise comparing 308 the third signal with a reference signal. For example, method 300 may compare the strength of the third signal with a predetermined threshold, or with the strength of a reference signal.

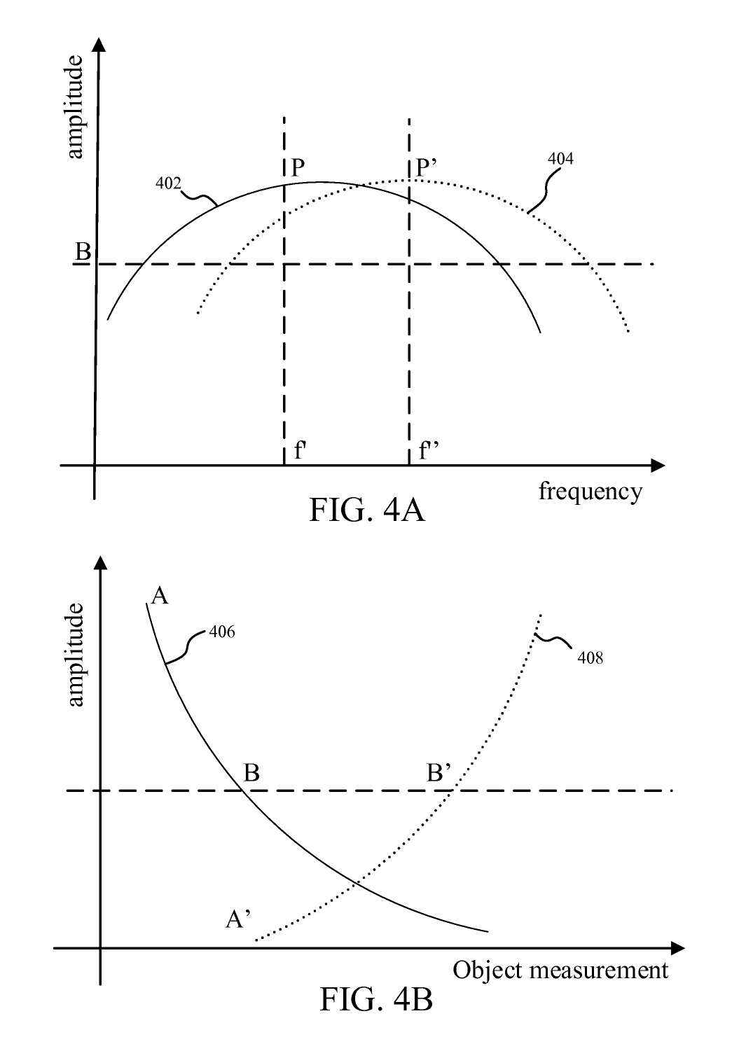

FIG. 4A illustrates frequency profiles of antenna 218 or 224. In one embodiment, when object 223 has a first measurement/characteristic, the frequency profile of non-linear device 222 may be represented by curve 402, where the received signal strength reaches the peak at point P. When object 223 has a second measurement/characteristic, the frequency profile of antenna 218 or 224 may be shifted to the right (the frequency profile may be shifted to the left in some embodiments) and is represented by curve 404, where the received signal strength reaches the peak at point P′.

If only signal at a certain frequency f (e.g., the frequency of signal 226) is examined when object 223 has a first and a second measurements/characteristics, a decrease (or an increase, depending on the direction of frequency profile shift of non-linear device 222) in strength (i.e., amplitude) of signal 226 can be observed when the measurement/characteristic of object 223 changes from a first measurement/characteristic to a second measurement/characteristic. The change of signal strength of signal 226 with measurement/characteristic of object 223 is illustrated in FIG. 4B.

A method for wireless sensing can use curve 406 if the received signal strength decreases when the measurement/characteristic of object 223 increases or curve 408 when the received signal strength increases when the measurement/characteristic of object 223 increases. For example, when the object is a medicine in a capsule in a human body, the sensing apparatus in FIG. 2 can be set such that when the medicine is full in the capsule, the signal strength (e.g., amplitude) of signal 226 corresponds to point A. When the medicine is released into the human body, the strength of signal 226 reduces as the remaining amount of the medicine reduces, and the measured strength of signal 226 may fall on a point on the curve to the right of A. In one embodiment, the method can be designed so that when the measured strength of signal 226 is less than threshold B, the medicine should be replaced. A similar design could be applied to cases where the object is a container, a living tissue, or food, and the appropriate curve (406 or 408) could be used.

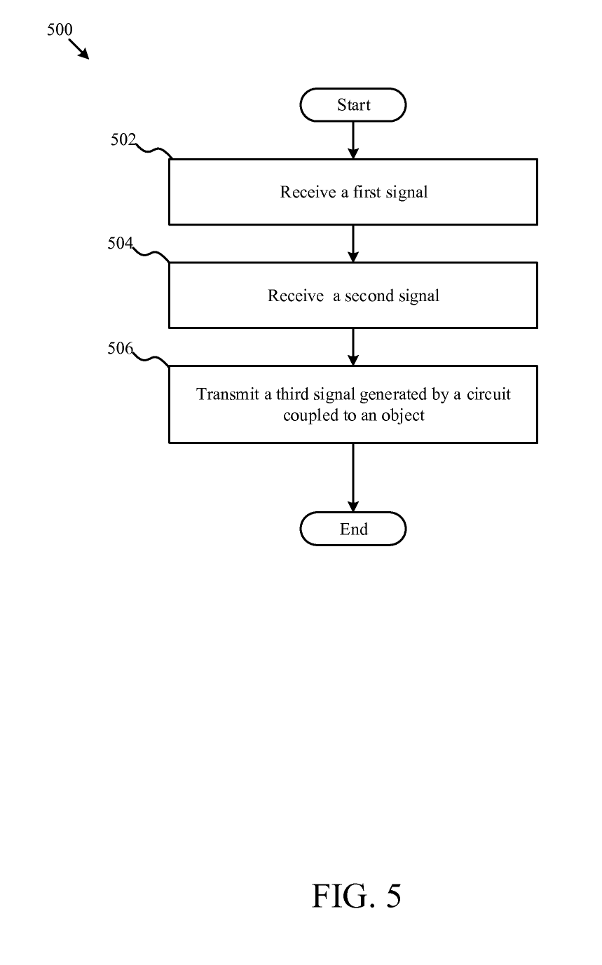

FIG. 5 illustrates one embodiment of method 500 for wireless sensing with system 200. In one embodiment, the method 500 comprises receiving 502 a first signal comprising a first frequency f₁, receiving 504 a second signal comprising a second frequency f₂, and transmitting 506 a third signal comprising a third frequency f₃. The first signal and second signal may be received simultaneously or at different times. Frequency f₃ is determined by formula f₃=m×f₁+n×f₂, where m, n are real numbers (positive, negative, or zero). In some embodiments, the third frequency of the third signal equals to the sum of (i.e., m=1, n=1) or the difference (i.e., m=1, n=−1; or m=−1, n=1) between the first and second frequencies. The third signal may be generated by a sensing component coupled to the object, and based on the first and second signals. Strength of the third signal varies with a measurement and/or characteristic of the object (see discussions above).

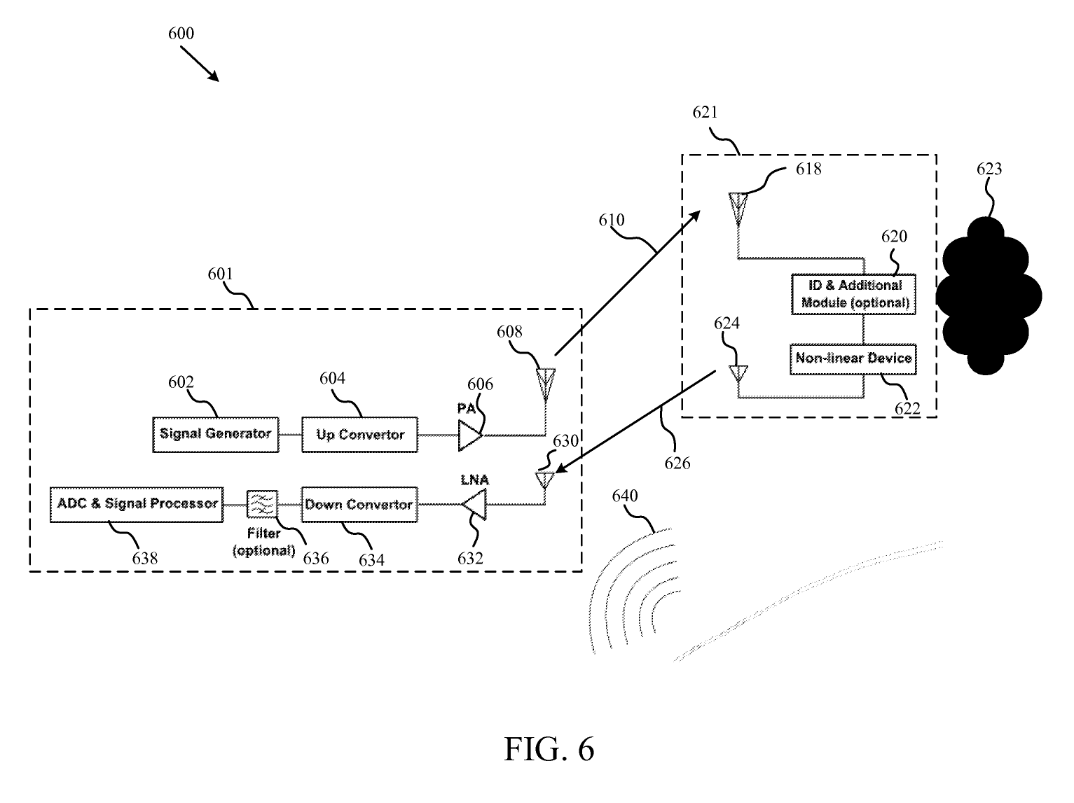

FIG. 6 illustrates one embodiment of a system 600 for wireless sensing. The system 600 may comprise a reader 601 and a sensing apparatus 621. In one embodiment, the reader 601 may comprise a signal generator 602, an up converter 604, a power amplifier 606, and a transmitting antenna 608. The reader 601 may also comprise a receiving antenna 630, a low noise amplifier 632, a down converter 634, an optional filter 636, and an analog to digital converter (ADC) and processor 638. In one embodiment, the sensing apparatus 621 may comprise a receiving antenna 618, a non-linear device 622, a transmitting antenna 624, and an optional module 620. In one embodiment, reader 601 and/or sensing apparatus 621 may comprise one or more radio frequency circuits. Sensing apparatus 621 may be included in a RFID tag.

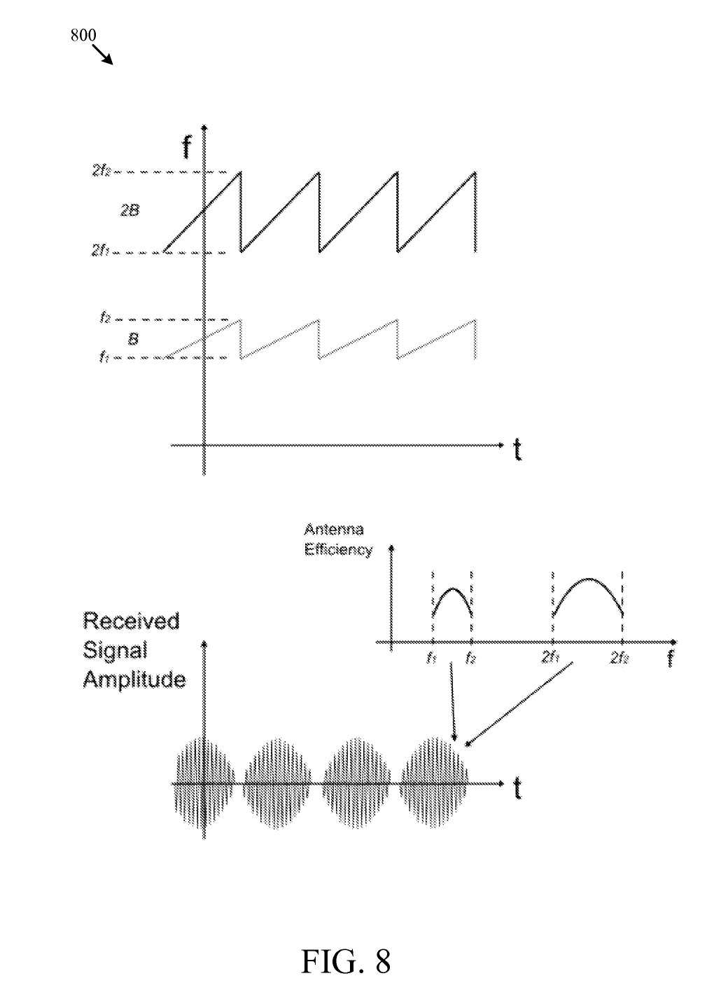

Signal generator 602 may be configured to generate signals at various frequencies. In system 600, signal generator 602 may be configured to generate signal 610, which may be a time varying frequency sweeping or hopping signal in a frequency range, or a wideband signal covering a frequency range. Such sweeping signal is illustrated in the top part of FIG. 8. Other parts of reader 601 works similarly to their counterparts in FIG. 2.

Non-linear device 622 is configured to generate harmonic signals of the input signal 610. For example, non-linear device 622 may be a frequency multiplier configured to generate signals with frequencies that are integer multiple of the input signal 610. Sensing apparatus 621 may be coupled to an object 623, and strength of the output signal 626 at a specific frequency may vary with a measurement and/or characteristic of the object (see discussions above).

Signal processor 638 may be configured to measure the strength of received signal 626 at each frequency in the frequency range of signal 626 and determine a measurement and/or characteristic of the object by evaluating signal 626. Signal processor 638 may also be configured to compare received signal 626 with a reference signal.

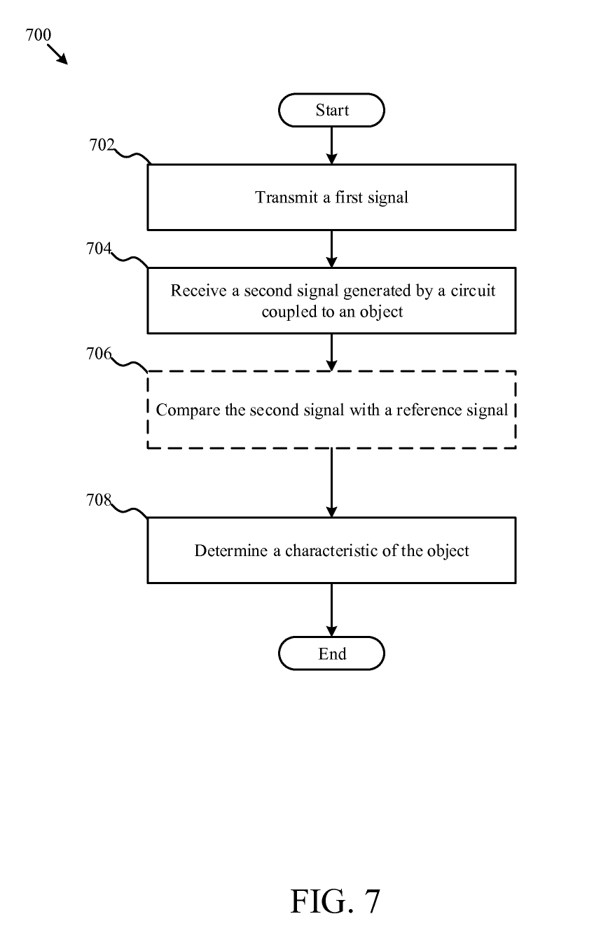

FIG. 7 illustrates one embodiment of method 700 for wireless sensing with system 600. In one embodiment, the method 700 comprises transmitting 702 a first signal, receiving 704 a second signal generated with an object. The first signal is either a sweeping signal with time-varying signals at frequencies in a frequency range or a wideband signal covering a frequency range. The second signal has signal components with frequencies two times that of the corresponding components in the first signal. For example, if the first signal covers a frequency range (f₁, f₂), then the second signal has a frequency range (2f₁, 2f₂), as illustrated in FIG. 8. The second signal may be generated by a sensing component coupled to the object, and based on the first signal. Strength of each frequency component of the second signal varies with a measurement and/or characteristic of the object (see discussions above). Method 700 further comprises determining 708 a measurement and/or characteristic of the object, e.g., by evaluating the strength of the second signal. Method 700 may optionally comprise comparing 706 the third signal with a reference signal. For example, method 700 may compare the received signal strength profile the second signal (as illustrated in FIG. 8) with a predetermined reference signal profile. For example, when the object is a medicine in a human body, the received signal strength profile may show that the strength of signal 626 peaks at frequency f_{A}, and when the body absorbs the medicine for a certain amount, the strength of signal 626 peaks at frequency f_{B}. By evaluating the difference between frequencies f_{A} and f_{B}, the remaining amount of the medicine can be determined. Similarly, a measurement and/or characteristics can be determined when the object is a container, food, or a living tissue.

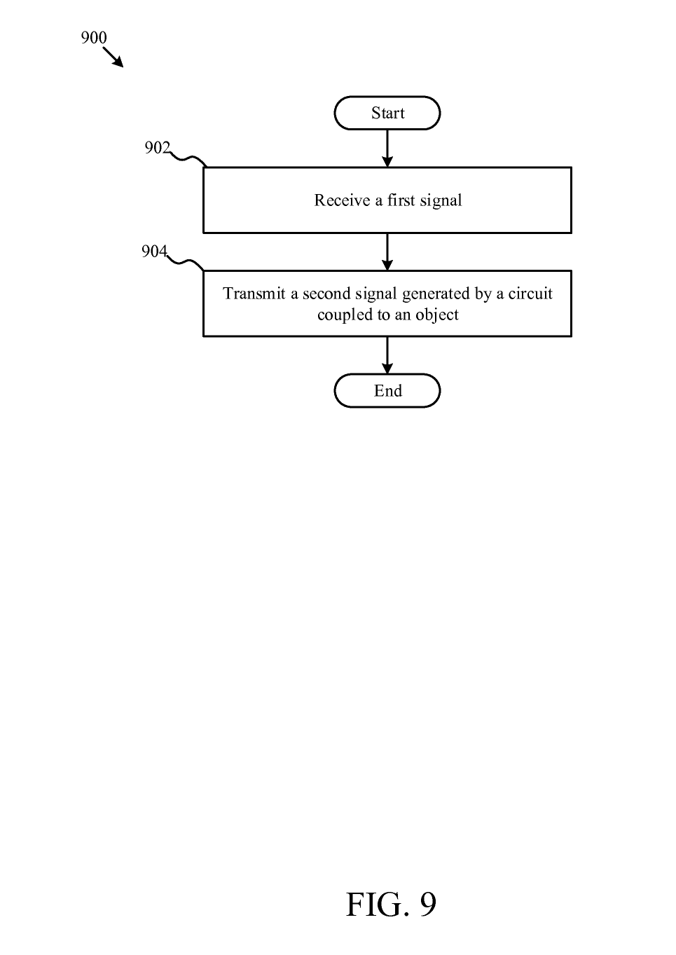

FIG. 9 illustrates one embodiment of method 900 for wireless sensing with system 600. In one embodiment, the method 900 comprises receiving 902 a first signal, and transmitting 904 a second signal. The first signal is either a sweeping signal with time-varying signals at frequencies in a frequency range or a wideband signal covering a frequency range. The second signal has signal components with frequencies two times that of the corresponding components in the first signal. For example, if the first signal covers a frequency range (f₁, f₂), then the second signal has a frequency range (2f₁, 2f₂), as illustrated in FIG. 8. The second signal may be generated by a sensing component coupled to the object, and based on the first signal. Strength of each frequency component of the second signal varies with a measurement and/or characteristic of the object (see discussions above).

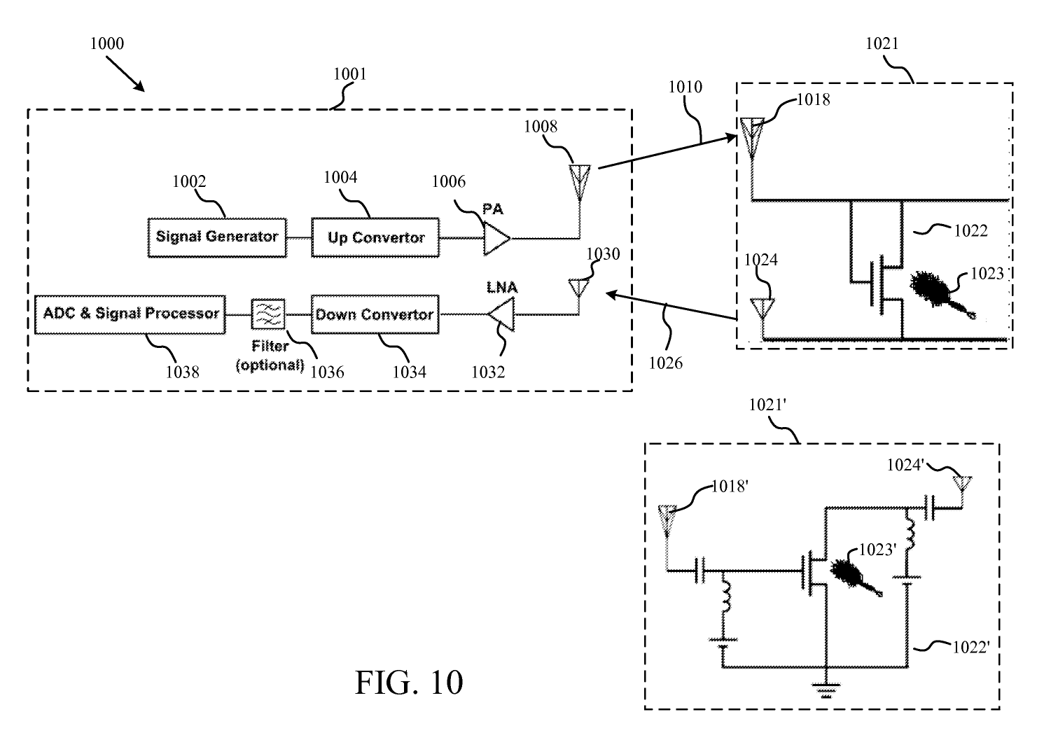

FIG. 10 illustrates one embodiment of a system 1000 for wireless sensing. The system 1000 may comprise a reader apparatus 1001 and a sensing apparatus 1021. In one embodiment, the reader 1001 may comprise a signal generator 1002, an up converter 1004, a power amplifier 1006, and a transmitting antenna 1008. The reader 1001 may also comprise a receiving antenna 1030, a low noise amplifier 1032, a down converter 1034, an optional filter 1036, and signal processor 1038. In some embodiments, system 1000 may also comprise an analog to digital converter (ADC). In one embodiment, the sensing apparatus 1021 may comprise a receiving antenna 1018, a sensing circuit 1022, and a transmitting antenna 1024. In one embodiment, reader 1001 and/or sensing apparatus 1021 may comprise one or more radio frequency circuits.

Signal generator 1002 may be configured to generate signals at various frequencies. In system 1000, signal generator 1002 is only required to generate signal 1010 at a first frequency. Antenna 1030 may be designed to receive a signal at a certain frequency (e.g., a frequency two times of the frequency of signal 1010), and reject signals at other frequencies. Other components of reader 1001 work similarly to their corresponding components described in FIG. 2.

Sensing circuit 1022 may be a non-linear device configured to output signals with frequencies different from frequencies of input signals. In one embodiment, sensing circuit 1022 may comprise a nonlinear transistor exposed to an object 1023. The nonlinear transistor may be configured to generate harmonic signals, i.e., signals with frequencies of integer multiples of frequency of the input signal, when applying a gate-source DC (direct current) bias V_{gs} equal or close to the nonlinear transistor's charge neutrality point. The nonlinear transistor shown in sensing apparatus 1021 has a charge neutrality point of zero (0), and thus, no DC bias is applied to the nonlinear transistor.

Alternatively, sensing apparatus 1021′ may comprise a nonlinear transistor with a non-zero charge neutrality point. In this case, a DC bias voltage equal to or close to the charge neutrality point may be added to the nonlinear transistor. For example, for a nonlinear transistor with a charge neutrality point at 0.5 volt, if the V_{gs} bias set to 0.5 volt, a small drain-source bias V_{ds} is applied (e.g., 10 mV), and a low voltage AC signal (e.g., 5 mV) at frequency 900 MHz is applied to the gate of the nonlinear transistor, the output drain-source signal will have strong harmonic component at frequency 1.8 GHz (along with a signal component at 900 MHz). However, if the V_{gs} bias is set at a voltage much different from 0.5 volt, the output drain-source signal will have a weak harmonic component at frequency 1.8 GHz (along with a relatively strong component at frequency 900 MHz).

On the other hand, the charge neutrality point of a nonlinear transistor is sensitive to the exposure of certain agents, such as toxic gas and some bio-agent liquid. For example, for a nonlinear transistor with charge neutrality point at 0 volt, exposing the nonlinear layer to a certain amount of agent (e.g., toxic gas or bio-agent) will shift the charge neutrality point to a positive voltage. The larger the amount of the agent, the higher the charge neutrality point will shift to. Therefore, if an input signal at frequency 900 MHz is applied to the nonlinear transistor, with a DC bias V_{gs} equal or close to the nonlinear transistor's charge neutrality point, the output will have a strong component at frequency 1.8 GHz (i.e., the harmonic component). After exposing the nonlinear transistor to a certain amount of agent, the signal strength of the component at frequency 1.8 GHz will significantly reduce.

In one embodiment, DC bias V_{gs} of the nonlinear transistor of sensing circuit 1022 is set to its charge neutrality point. Signal processor 1038 may be configured to continuously receive signal 1040 from sensing circuit 1021 and monitor the strength of the received signals 1040. Signal processor 1038 may be configured to determine a measurement/characteristic of object 1023 (e.g., toxic gas or a bio-agent). Signal processor 1038 may also be configured to compare the received signal strength with a predetermined threshold or a reference signal.

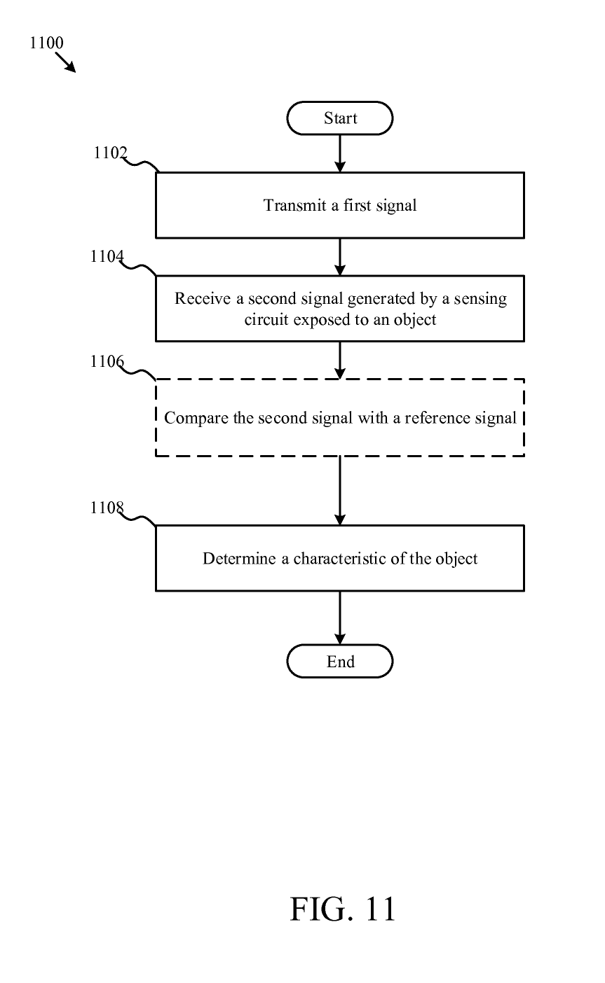

FIG. 11 illustrates one embodiment of method 1100 for wireless sensing with system 1000. In one embodiment, the method 1100 comprises transmitting 1102 a first signal, and receiving 1104 a second signal generated by a sensing circuit exposed to an object. The sensing circuit may comprise a nonlinear transistor. The object may be an agent such as toxic gas or a bio-agent. Method 1100 may also comprise determining 1108 a measurement/characteristic of the object, e.g., based on the strength of the second signal. Method 1100 may optionally comprise comparing 1106 the signal strength of the second signal with a reference signal or a predetermined threshold.

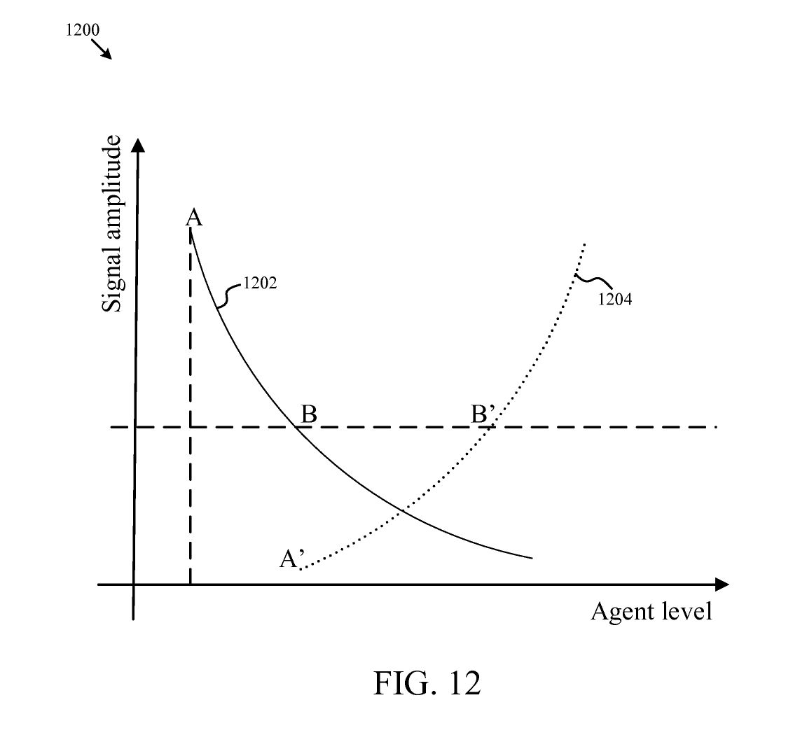

FIG. 12 illustrates a graph depicting a measurement and/or characteristics of a signal that can be used for a method for wireless sensing. For example, when sensing circuit 1121 is exposed to no agent, the strength of received signal 1026 corresponds to point A. When sensing circuit 1121 is exposed to certain amount of agent (e.g., toxic gas or certain bio-agent), the strength of the received signal 1026 may correspond to a point of the curve to the right of point A. In one embodiment, the method can be designed so that when the measured strength of signal 1126 is less than threshold B, an alarm signal is transmitted and/or displayed by reader apparatus 1101.

In some embodiments, when sensing circuit 1121 is not exposed to any agent, the received signal strength may correspond to point A′, and when sensing circuit 1121 is exposed to certain amount of agent (e.g., toxic gas or certain bio-agent), the strength of the received signal 1026 may correspond to a point of the curve to the right of point A′. The method can be designed so that when the measured strength of signal 1126 is greater than threshold B′, an alarm signal is transmitted and/or displayed by reader apparatus 1101.

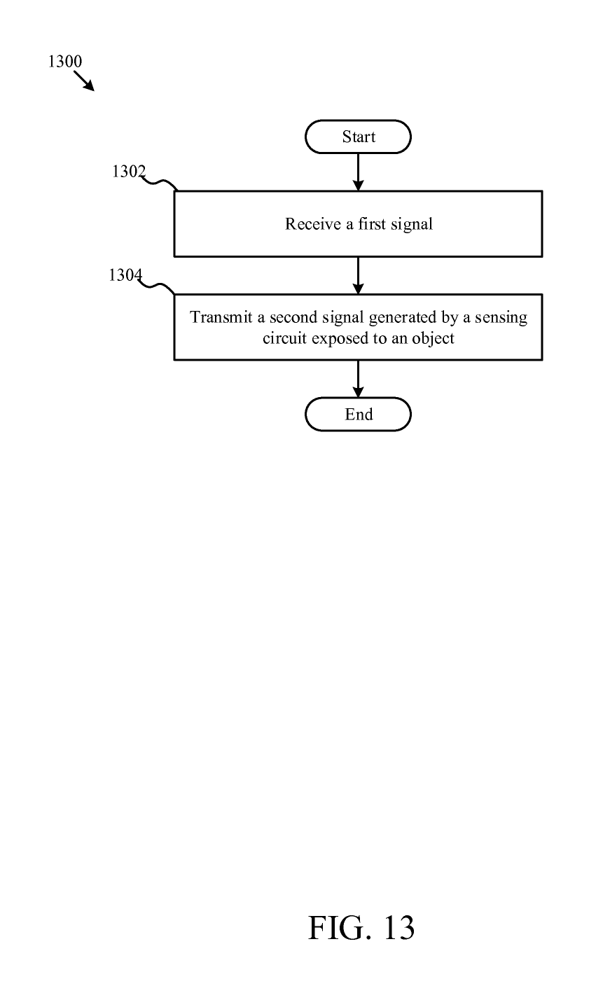

FIG. 13 illustrates one embodiment of method 1300 for wireless sensing with system 1000. In one embodiment, the method 1300 comprises receiving 1302 a first signal a first frequency, and transmitting 1304 a second signal comprising a second frequency. The second frequency of the second signal may be two times of the first frequency of the first signal. The second signal may be generated by a sensing circuit exposed to an object (e.g., toxic gas or a bio-agent) and based on the first signal. Strength of each frequency component of the second signal varies with a measurement and/or characteristic of the object (see discussions above).

### EXAMPLES

The following describe scenarios that may be used with various embodiments of the disclosed invention. These examples are not intended to be limiting, but rather to provide specific uses for different embodiments of the disclosed invention.

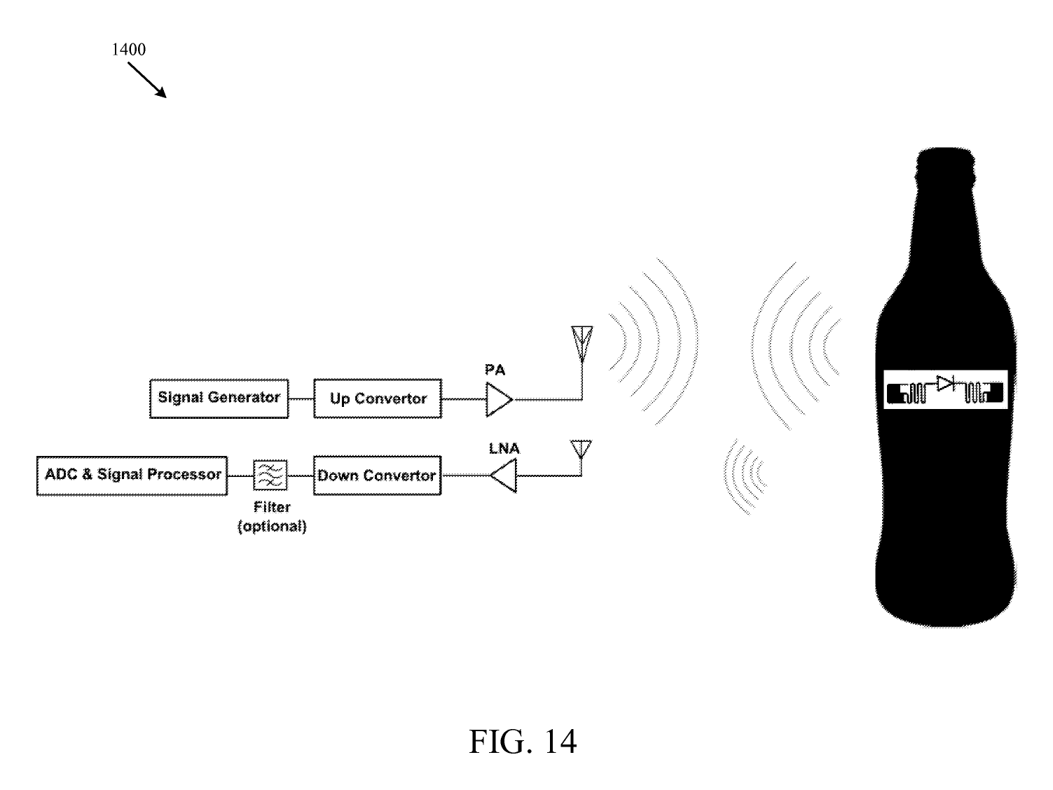

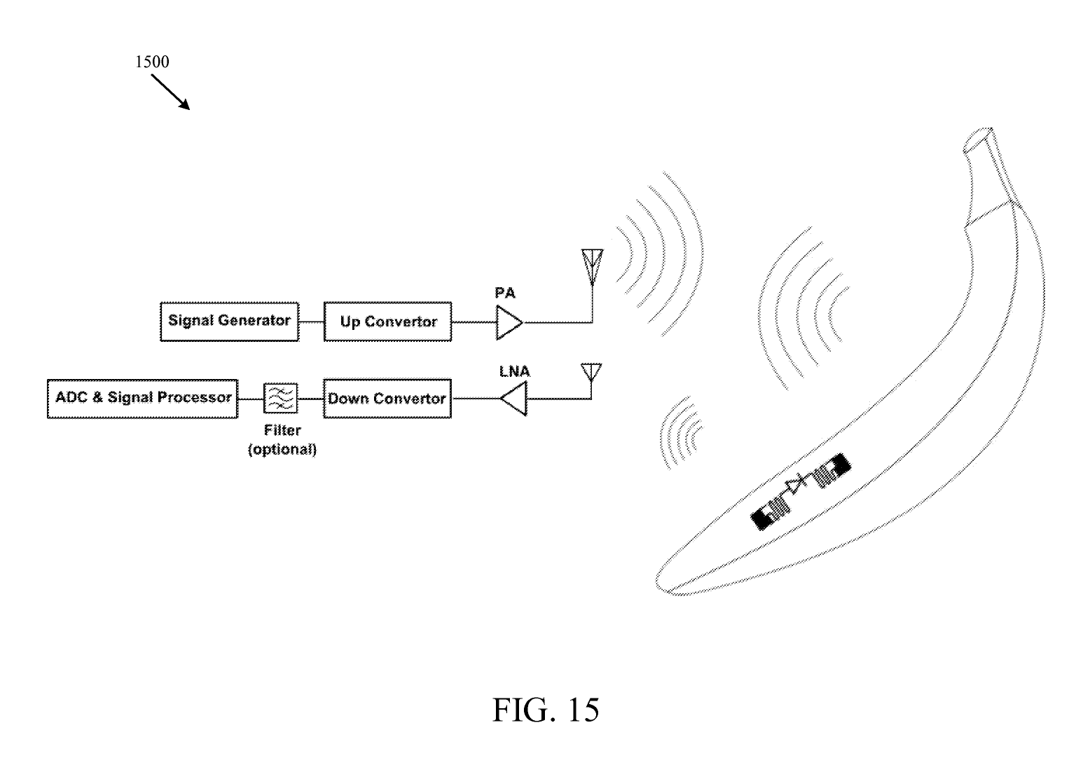

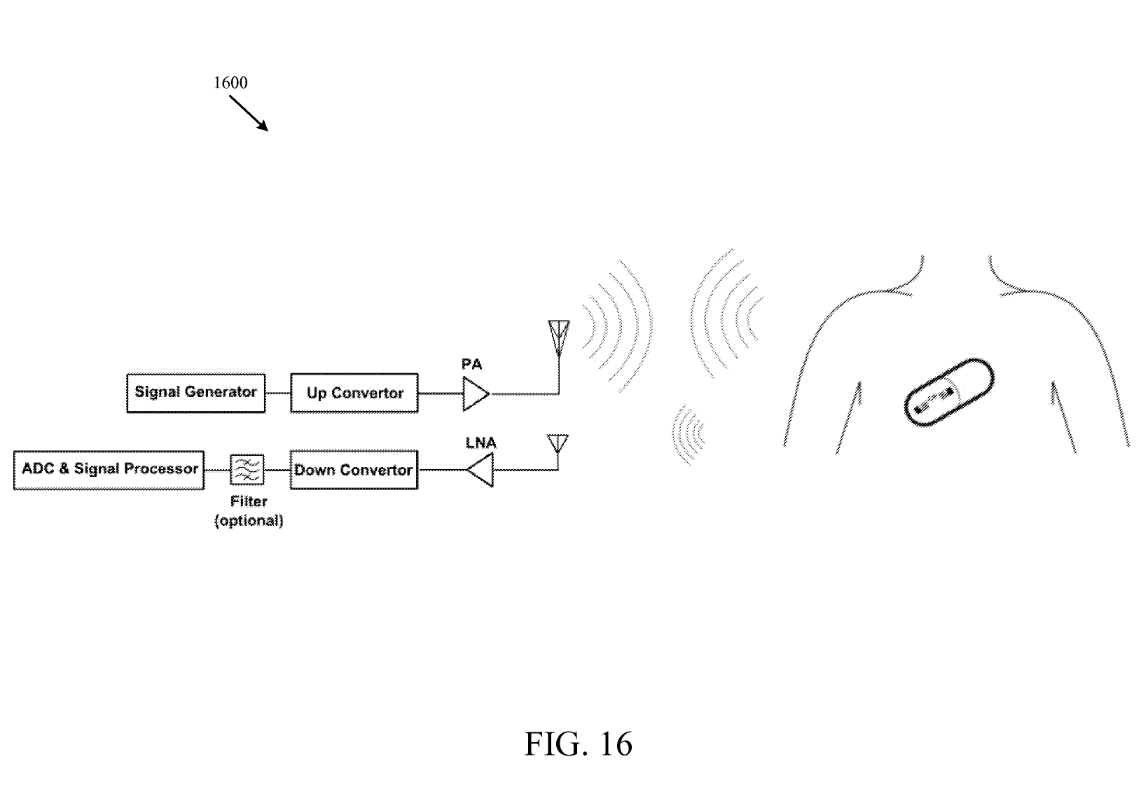

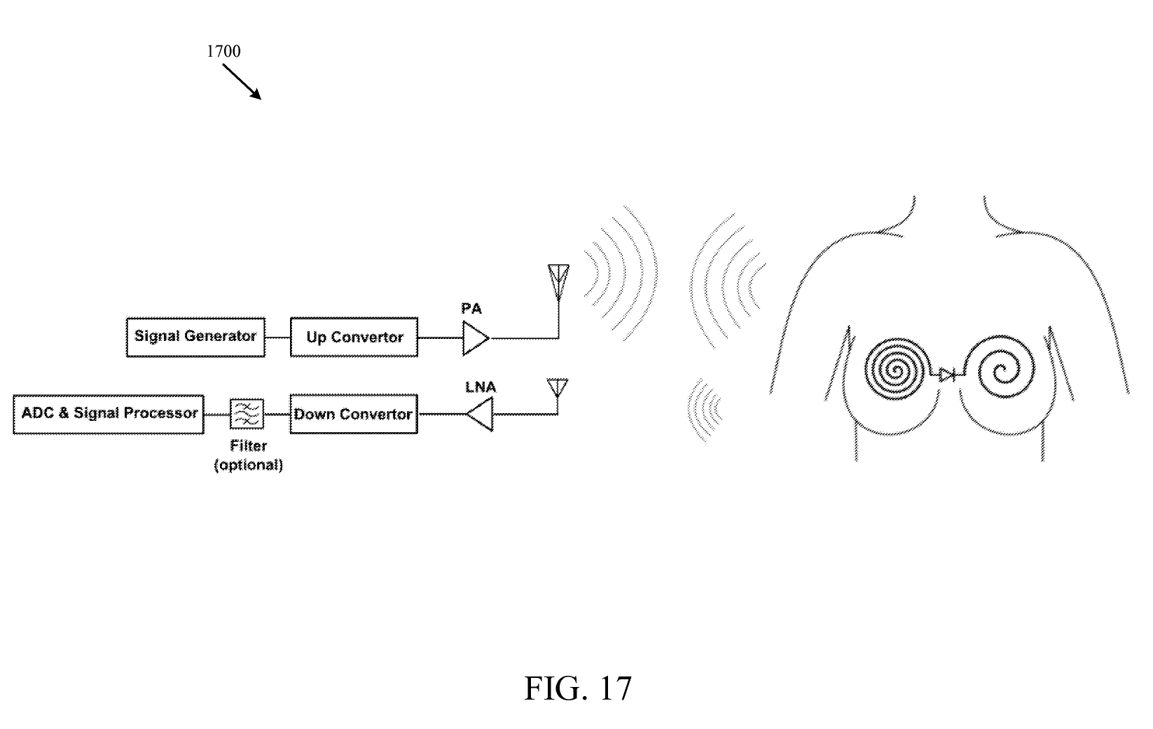

FIGS. 14-17 illustrate exemplar applications of wireless sensing systems 200 and/or 600 described in FIGS. 2 and 6. FIG. 14 illustrates an exemplar application where a sensing unit is coupled to a bottle. By measuring and evaluating the strength of received signal, the reader apparatus may be able to determine the level of the fillings (e.g., water, soda, alcohol, or other fluids) in the bottle. FIG. 15 illustrates an exemplar application where a sensing unit is coupled to a banana or other fruit or food. By measuring and evaluating the strength of received signal, the reader apparatus may be able to determine the quality of the banana. FIG. 16 illustrates an exemplar application where a sensing unit is coupled to a drug capsule in a human body. By measuring and evaluating the strength of received signal, the reader apparatus may be able to determine the remaining amount of the drug in the human body. FIG. 17 illustrates an exemplar application where a sensing unit is coupled to a breast of a female. By measuring and evaluating the strength of received signal, the reader apparatus may be able to determine whether there is any tumor and the potential amount of the tumor in the breast of the female.

The above specification and examples provide a complete description of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present invention are not intended to be limited to the particular forms disclosed. Rather, they include all modifications and alternatives falling within the scope of the claims, and embodiments other than the one shown may include some or all of the features of the depicted embodiments. For example, components may be combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method comprising:
transmitting a first signal comprising of a first frequency f₁; and
receiving a second signal comprising a second frequency f₂, the second signal generated with an object and based on the first signal;
wherein the second frequency f₂ of the second signal is determined by formula f₂=m×f₁, where m is a non-unity real number.

2. The method of claim 1, further comprising comparing the second signal with one or more reference signals, wherein the reference signal is the second signal at varying times in response to the second signal having a time-varying frequency.

3. (canceled)

4. (canceled)

5. The method of claim 1, wherein the second signal is generated by a component coupled to an object, and a property of the second signal is related to a measurement of the object.

6. The method of claim 5, wherein the object is a container and the measurement is a property of some liquid filling in the container.

7. The method of claim 5, wherein the object is food and the measurement is a quality of the food.

8. (canceled)

9. The method of claim 4, wherein the object is a part of living tissue and the measurement is the abnormality or normality of the tissue.

10. A method comprising:
receiving a first signal comprising of a first frequency f₁; and
transmitting a second signal comprising of a second frequency f₂, the second signal generated based on the first signal;
wherein the second frequency f₂ of the second signal is determined by formula f₂=m×f₁, where m is a non-unity real number.

11. (canceled)

12. The method of claim 10, wherein the second signal is generated by a component coupled to an object, and a property of the second signal is related to a measurement of the object.

13. The method of claim 10, further comprising comparing the second signal with one or more time varying reference signals.

14. An apparatus comprising:
a transmitter configured to transmit a first signal comprising of a first frequency f₁; and
a receiver configured to receive a second signal comprising of a second frequency f₂, the second signal generated with an object and based on the first signal;
wherein the second frequency f₂ of the second signal is determined by formula f₂=m×f₁, where m is a non-unity real number.

15. The apparatus of claim 14, further comprising a processor configured to compare the second signal with one or more time-varying reference signals.

16. The apparatus of claim 14, wherein the second signal is generated by a component coupled to an object, and a property of the second signal is related to a measurement of the object.

17. (canceled)

18. An apparatus comprising:
a receiver configured to receive a first signal comprising of a first frequency f₁; and
a circuit configured to generate a second signal comprising of a second frequency f₂ based on the first signal; and
a transmitter configured to transmit the second signal;
wherein the second frequency f₂ of the second signal is determined by formula f₂=m×f₁, where m is a non-unity real number.

19. (canceled)

20. The apparatus of claim 16, wherein the circuit is coupled to an object, and a property of the second signal is related to a measurement of the object.

21. (canceled)

22. The apparatus of claim 16, wherein the circuit comprises a frequency multiplier.

23. The apparatus of claim 16, wherein the receiver is coupled to an object, and a property of the second signal is related to a measurement of the object.

24. The apparatus of claim 16, wherein the transmitter is coupled to an object, and a property of the second signal transmitted by the transmitter is related to a measurement of the object.

25. The method of claim 1, further comprising transmitting a third signal comprising of frequency f₃, wherein the signal generated by the object comprises the frequency f₂, wherein f₂ is determined by formula f₂=m×f₁+n×f₃, where m,n are real numbers so that f₂ is different from f₁, and from f₃.

26. The method of claim 10, further comprising receiving a third signal comprising of frequency f₃, wherein the second signal transmitted by the method comprises the frequency f₂, wherein f₂ is determined by formula f₂=m×f₁+n×f₃, where m,n are real numbers so that f₂ is different from f₁, and from f₃.

27. The apparatus of claim 14, further comprising a transmitter configured to transmit a third signal comprising of frequency f₃, wherein the receiver configured to receive a second signal comprising of a second frequency f₂, wherein f₂ is determined by formula f₂=m×f₁+n×f₃, where m,n are real numbers so that f₂ is different from f₁, and from f₃.

28. The apparatus of claim 16, wherein the receiver further configured to receive a third signal comprising of frequency f₃; wherein the circuit configured to generate a second signal comprising of a second frequency f₂; and the transmitter configured to transmit the second signal, wherein f₂ is determined by formula f₂=m×f₁+n×f₃, where m,n are real numbers so that f₂ is different from f₁, and from f₃.
